(19) United States
(12) Patent Application Publication
(10) Pub. No.: US 2021/0380432 A1
(43) Pub. Date: Dec. 9, 2021

(54) Processes for Making Nanoparticles, Bulletproof Glass, Bulletproof Armor, Hardened Casts, Hardened Parts, Nonstructural Reinforced Hardened Casts, Structural Shrapnel-Resistant Blocks, Attachable Hardened Surfaces, and for Hardening Surfaces

(71) Applicant: All American Armor Global L.L.C., Fort Lauderdale, FL (US)

(72) Inventor: Michael Todd Wharton, Fort Lauderdale, FL (US)

(73) Assignee: All American Armor Global L.L.C., Fort Lauderdale, FL (US)

(21) Appl. No.: 17/338,636

(22) Filed: Jun. 3, 2021

Related U.S. Application Data
(60) Provisional application No. 63/034,201, filed on Jun. 3, 2020.

(51) Int. Cl. C01F 17/10; F41H 5/02; C01B 32/184; C08K 3/08; C08K 3/04

(52) U.S. Cl. CPC C01F 17/10; F41H 5/023; B82Y 30/00; C08K 3/08; C08K 3/042; C01B 32/184

(57) ABSTRACT

Processes for making lightweight armor, hardened casts, hardened parts, nonstructural reinforced hardened casts, structural shrapnel-resistant blocks, attachable hardened surfaces, and for hardening surfaces utilize rare earth material nanoparticles including metal anhydride nanoparticles that are refined under supercritical conditions.

### CROSS-REFERENCE TO RELATED APPLICATIONS

This application claims the benefit of U.S. Provisional Application No. 63/034,201, filed Jun. 3, 2020, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to methods for manufacturing nanoparticles and methods for making nanoparticle reinforced materials.

### Description of the Related Art

Bulletproof glass, ballistic glass, transparent armor, or bullet-resistant glass is a strong and optically transparent material that is particularly resistant to penetration by projectiles. Like any other material, bulletproof glass is not completely impenetrable. Bullet-resistant materials are tested using a gun to fire a projectile from a set distance into the material, in a specific pattern. Levels of protection are based on the ability of the target to stop a specific type of projectile traveling at a specific speed. A standard for bullet-resisting equipment is available under the certification mark UL STANDARD 752.

### BRIEF SUMMARY OF THE INVENTION

An object of the invention is to provide processes for making lightweight bulletproof glass, armor, hardened casts, hardened parts, nonstructural reinforced hardened casts, structural shrapnel-resistant blocks, attachable hardened surfaces, and for hardening surfaces that overcome the disadvantages of the processes of this general type and of the prior art.

With the foregoing and other objects in view there is provided, in accordance with the invention, a process for making nanoparticles. The process includes the following steps.

1. grinding particles of rare-earth material to a particle size between ten and twenty nanometers to create processed rare-earth material; rare-earth metals include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). They are often found in minerals with thorium (Th), and less commonly uranium (U);

2. mixing said processed rare-earth material with a positively charged aqueous dispersion to create a slurry;

3. admixing the slurry to silica gel to create a rare-earth gel;

4. sublimating the rare-earth gel by increasing at least one of temperature and pressure.

5. deposing rare-earth-material nanoparticles by decreasing at least one of the temperature and the pressure;

6. dehydrating the rare-earth material nanoparticles to form a nanoparticle powder;

7. sublimating silicone graphene by increasing at least of temperature and pressure to created sublimated graphene;

8. deposing graphene powder by reducing at least one of the temperature and the pressure of said sublimated graphene;

9. mixing said graphene powder and said nanoparticle powder to make graphene/nanoparticle powder;

10. admixing epoxy resin with said graphene/nanoparticle powder to make nanoparticle epoxy resin;

11. grinding said nanoparticle epoxy resin to one nanometer particle size;

12. admixing epoxy-resin hardener to said nanoparticle epoxy resin to make a hardening nanoparticle epoxy resin;

13. applying said hardening nanoparticle epoxy resin to a sheet of polyaramid or other multidirectional fabrics to produce a nanoparticle enriched sheet;

14. pressing said nanoparticle enriched sheet to produce a pressed nanoparticle enriched sheet;

15. curing said pressed nanoparticle enriched sheet by applying heat to create a cured nanoparticle enriched sheet; and

16. cold stretching said cured nanoparticle enriched sheet to produce a stretched and cured nanoparticle enriched sheet.

To make clear armor, before 13, two sheets of clear composite or plastic (e.g., a polycarbonate sold under the trade name LEXAN®) are placed parallel to each other with a space between. Then a seal connects the perimeter of the two sheets and holds them spaced from each other. Two air gaps are left at the top of the seal. A first air gap is for filling the inter-sheet space. A second air gap is for bleeding out air trapped in the inter-sheet space. The seal can be made with double sided tape or neoprene. The gap between layers is 0.16 cm. The space is filled by pumping nanoparticles into the inter-planar space. In the second gap, a negative pressure pump is connected until the nanoparticle liquid fills cavity.

After filling the inter-sheet space, the filled sheets are placed on a cold fusion table. Cycles 1.0×10⁴ Barye of negative pressure at 316° C. The sheets are placed inside an airtight bag to apply the negative pressure. Cures for twenty-four hours (24 hrs.). The negative pressure removes any air between the layers and degasses the liquid. Repeat the process an additional time.

Metal acetylacetonates are acceptable rare earth materials. Examples of metal acetylacetonates include magnesium acetylacetonate, manganese acetylacetonate, sodium acetylacetonate, aluminum acetylacetonate, and yttrium (III) acetylacetonate.

Ferrofluids are an example of positively charged aqueous dispersion.

The rare-earth material nanoparticles can be refined by repeating the sublimation and deposition of the rare-earth material nanoparticles. While the refinement improves with each successive cycle, four cycles has been found to be a particularly useful number of sublimation/deposition cycles.

Like the rare-earth material nanoparticles, the graphene powder can be refined by repeating the sublimation and deposition of the graphene powder.

A further object of the invention is tuning a cured nanoparticle enriched sheet with sound. The sound can be between 7.83 Hz and 30 Hz. The sound can be cycled between 7.83 Hz and 30 Hz and back to 7.83 Hz over thirty minutes.

A further object of the invention is to provide a process for making a hardened cast. The process involves pouring a slurry of processed rare-earth material and a positively charged aqueous dispersion into a mold. The next step is curing said slurry in said mold by applying at least one of heat and negative pressure until dry to make a hardened part within said mold.

A further object of the invention is to provide a process for making a reinforced hardened part. The process includes applying a stretched and cured nanoparticle enriched sheet to a hardened part. A layer of polyethylene can be placed between the stretched and cured nanoparticle enriched sheet and the hardened part. A further hardened part can be applied to said stretched and cured nanoparticle enriched sheet.

A further object of the invention is to provide a process for making a nonstructural reinforced hardened cast. The process includes attaching a bladder to an outer surface of said reinforced hardened part. The process can include filling said bladder with a non-Newtonian fluid.

A further object of the invention is to provide a process for making a structural shrapnel-resistant block. The process includes enclosing a reinforced hardened part with a cloth bag.

A further object of the invention is to provide a process for making an attachable hardened surface. The process includes the step of forming a hole through a reinforced hardened part.

A further object of the invention is to provide a process for hardening a surface of a structure. The process includes inserting a fastener into a hole in an attachable hardened surface. The next step is securing said fastener to the surface of the structure.

A further object of the invention is to provide the products made according to the Processes for Making Lightweight Armor, Hardened Casts, Hardened Parts, Nonstructural Reinforced Hardened Casts, Structural Shrapnel-Resistant Blocks, Attachable Hardened Surfaces, and for Hardening Surfaces.

An object of the invention is to provide bulletproof material that satisfies UL STANDARD 752, LEVEL 4. Radiation glass, add nanoparticle lead particles in, Absorbs/blocks radiation, add 80% lead 20% nano composite. Use the same process as making bulletproof glass.

With the foregoing and other objects in view there is provided, in accordance with the invention, an extreme high impact glazing with frames that can sustain 362 kph winds.

Other features that are considered as characteristic for the invention are set forth in the appended claims.

Although the invention is illustrated and described herein as embodied in processes for making lightweight armor, hardened casts, hardened parts, nonstructural reinforced hardened casts, structural shrapnel-resistant blocks, attachable hardened surfaces, and for hardening surfaces, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

Not applicable

### DETAILED DESCRIPTION OF THE INVENTION

A preferred embodiment of a process for making a slurry of nanoparticles includes the following steps. Each step is performed at standard temperature and pressure unless otherwise noted.

### VORTEX PROCESS FOR LIQUID OR DRY NANOPARTICLES

The speed of the vortex and the angle of the axis (i.e., tilt of reactor) are important. When the speed and tilt are correct, an increase rate of nanoparticles will occur.

After leaving the reactor, the product then can be further refined in a dry or liquid process. The nanoparticle product dries as it spins in cone-section below the introduction of condensate.

### DRY PROCESS

Beginning with a rare-earth/silica salt liquid base (starting material), thirty to forty-six liters (30-461) of slurry is put in the reactor.

A proton beam at a low frequency (<9.8 Hz) is aimed through a vortex of nanoparticles. The proton beam is aimed axially, from the top of the vessel. The outside of the vessel is grounded. The vessel is a cylinder ˜3.0 m tall. At the bottom of the cylinder, is a cone. Six inches from the bottom of the vessel (i.e., at the bottom of the cone), a port for introducing condensate (i.e., water) is provided. The device includes a proton head that is wrapped in silver around the casing of the proton head and motor. The purpose is to ramp up volume of low-frequency energy. Pass the beam shot through mixture. Creates a vortex. Positive beam causes the particles to gain weight.

Drops the particles to bottom of the vessel to 80,000 rpm. Results in nanoparticles collecting at the bottom.

Hydrated (not liquid) nanoparticles are removed periodically as they collect.

An automated gate valve releases the nanoparticles. A porthole allows the particles to be viewed. Left with nanoparticles. Hydrogen gas (H₂) is there to be used as fuel. Oxygen gas (O₂) turns a turbine to generate electricity.

Proton beam is aimed into the center of the reactor. As the slurry is introduced around the outside of the proton beam with orifices that are 0.64 cm diameter of the proton head and are rotating around the proton beam (this is how the liquid/gel are introduced into the reactor). The proton beam separates electrons from neutrons. The proton beam is aimed axially from the top of the vortex.

Next, add a flammable gas mix:

Argon-40

Hydrogen

Helium

Oxygen.

In addition, carbon is introduced in the base material liquid/gel). Water is added to slow down the proton beam at the bottom of the cone of the reactor, introduced as a semi-supercritical state, above ambient air temperature and pressure).

The proton head is preferably spinning at least 80,000 rpm. This process creates a vortex in the reactor.

The proton beam starts at 7.2 Hz in frequency and increases to 9.7 Hz.

Condensers are connected at the bottom of cone. Evaporated water is condensed and returned to the reactor. The water absorbs the energy of the proton beam.

In the reactor, the helium is used to keep the negatively-charged neutrons elevated in order to build crystalline structures.

The proton head has 120 psi Helium. After pressure reaches 8.27×10⁶ Barye, then an operator can start removing particles from the reactor: Approximately a thirty minute (˜30 min) process.

When the operator lowers the helium, the operator can open the valve at the bottom of the cone and start removing crystalline nano particles (i.e., a “powder”).

At this point, the powder can be introduced back into the base liquid in order to make a liquid crystalline nano material.

### DRY NANO CRYSTALINE STRUCTURES

Powder is pumped into a packer.

Scale is used to record mass of particles in packaging.

A nitrogen pushing pump pushes powder from valve of the reactor the packer.

### REFINEMENT OF PARTICLES

Step 1. Beginning with particles of rare-earth material having a particle size between 37,000 and 44,000 nm, (I.e., the powder) grind the particles of rare-earth material to a particle size between 10 and 20 nm to create processed rare-earth material. The rare-earth material is selected from the group consisting of Magnesium metal (for example, Magnesium acetylacetonate (CAS No. 14024-56-7)), Maganic metal (for example, Manganese (II) acetylacetonate (CAS No. 14024-58-9)), Sodium (CAS No. 15435-719), Aluminum acetylacetonate (CAS No. 13963-57), and Yttrium (CAS 1554-47-9) or Yttrium (III) acetylacetonate (CAS No. 207801-29-4).

Step 2. Mix the processed rare-earth material with a positively charged aqueous dispersion with a stirrer to create a slurry. A preferred embodiment of the positively charged aqueous dispersion is a ferrofluid.

### INTRODUCTION OF LIQUID BASE MATERIALS INTO REFINED DRY NANO CRYSTALLINE STRUCTURES

Step 3. Add the slurry to silica gel to create a rare-earth gel/liquid. Tetraethyl orthosilicate (Si(OCH₃)₄) is a preferred silicate. To prepare the rare earth gel, start with methanol, add tetramethyl orthosilicate, add ammonia, then dry with methanol. To prevent cracking, prevent the methanol from fully evaporating from the rare-earth gel to produce a semi gel.

Step 4. Place the semi gel in a supercritical extractor. Increase the temperature within the extractor to 180° C. and to a pressure of 5.5158×108 Ba and hold at that temperature and pressure until the semi gel is fully sublimated. Then cool and depressurize the extractor to depose flakes of nanoparticles of rare-earth material. A preferred example of a supercritical extractor is sold under the trade name HA321-35-900 by NANTONG HUAAN.

Step 5. Increase the temperature and pressure with the supercritical extractor until the flakes of rare-earth material are dehydrated and form a nanoparticle powder.

Steps 4 and 5 can be repeated to further refine the nanoparticles of rare-earth material.

Step 6. Form graphene powder by placing silicone graphene in the supercritical extractor. Increase the temperature within the supercritical extractor to 180° C. and to a pressure of 5.5158×10⁸ Ba and hold at that temperature and pressure until the silicone graphene is fully sublimated as a supercritical fluid. Then, cool the silicone graphene and release the pressure in the supercritical extractor to cause the silicone graphene to depose in the supercritical extractor as graphene powder.

Step 6 can be repeated to further refine the nano liquid.

Step 7. Mix the liquid nano particles and the nanoparticle powder at a mass ratio of 2:1 to make nanoparticle slurry. Then, increase the temperature within the supercritical extractor to 180° C. and to a pressure of 5.5158×10⁸ Ba and hold at that temperature and pressure until the graphene/nanoparticle powder is fully sublimated. Then, cool the reactor and release the pressure within the supercritical reactor to normal lab conditions to cause the nanoparticle powder to depose in the reactor as nanoparticle powder.

Step 8. Mix epoxy resin with the nanoparticle powder to make nanoparticle epoxy resin (i.e., without hardener). The mass ratio of epoxy resin to powder is 15:1. A preferred example of an epoxy resin is sold under the trade name PC-11 by PC PRODUCTS. Let the nanoparticle epoxy resin set for twenty-four (34) hours.

Step 9. The nanoparticle epoxy resin is ground to 1 nm particle size.

Step 10. Mix the nanoparticle epoxy resin in a Ross Ribbon Blender. Then admix an equal amount of epoxy-resin hardener as the nanoparticle epoxy resin.

Step 11. Using a Zahn Viscosity Cup, Cup #5, test the mixture to get elevens seconds out of the viscosity cup. If the viscosity is too great, then add ten percent by weight of additional non-hardened resin. After this step, the hardening nanoparticle epoxy resin should be an acceptable viscosity to be applied by vortex sprayer.

Step 12. Apply the hardening nanoparticle epoxy resin to thirty-two (32) sheets of polyaramid. Each sheet of polyaramid is made of parallel polyaramid fibers. A preferred form of polyaramid is sold under the trade name NEW PROCESS FIBER COMPANY, INC. The direction of the polyaramid fibers is rotated ninety degrees from the previous sheet's thread orientation. Although other sizes are usable, a preferred size of the sheets are 122 cm by 305 cm. The hardening nanoparticle epoxy resin is applied used an epoxy vortex sprayer/atomizer such as those sold under the trade name EX-810 by DENACOL.

Step 13. Place the laminate in a multipress four-column press and apply 3.144×10⁷ Pa of pressure for at least thirty-six (≥36) hours.

Step 14. After removing the laminate from the press, the laminate is cured by heating the laminate for at least forty-eight hours, while cycling from 70.6° C. to 358° C. every thirty min for thirty minutes. A suitable walk-in oven is sold under the trade name LEWCO.

Step 15. Cold stretch to a minimum of ten percent (<10%) of thickness.

Step 16. Using a high-frequency generator such as those sold under the trade name HF-TYPE by ZEMAT, tune a chamber to 7.83 Hz for 438 minutes. Every fifteen minutes cycling from 7.83 to 30 Hz.

Step 17. Put the sheet on a Computer Numerical Control (CNC) cutting table and cut the laminate to shape to form a panel.

Step 18. Fire the panel in a kiln at 1,916° C. The silicone carbon is dehydrated after pressing the laminate in a mold for two days. Maintain 3.0 ba of pressure on the panel for 10 hours.

Step 19. Pour a portion of the slurry of processed rare-earth material in a positively charged aqueous dispersion into a part (i.e., workpiece) shaped mold. Vibrate the slurry for fifteen (15) minutes in the mold, add no epoxy. Put the filled mold in a thermovac aerospace vacuum heated treatment negative pressure furnace. Heat to 1,649° C. for twenty-four (24) hours. Then reduce the heat to 1093° C. for another twenty-four (24) hours. Apply 23 kg of negative pressure throughout both stages. The resulting product is molecularly hardened.

Step 20. Take a first of the two castings of the part. Place a first casting face down on a workbench. Place a layer of polyethylene on top of the first casting. Activate the polyethylene by wetting with the ferro fluid. Place 2 mm shims on top of the polyethylene. One shim per square foot. Activate the second polyethylene layer with ferro fluids containing refined nanoparticles that have been refined four times. Place two-millimeter (2 mm) shims on the second polyethylene. Spray activated nanoparticles on the polyethylene layer. Place the second cast of the activated ferro fluids. Bind the entire perimeter of the panel with structural heat-resistant casting tape. Place the assembled panel into a proprietary high-frequency, lamination, negative-pressure chamber. Heat the chamber to 510° C. for six hours. Within the first 90 minutes, turn on the vacuum pump to negative 114 V. At 200 minutes, turn on a frequency generator (two channel). That means generating two frequencies simultaneously. The first frequency channel is 7.83 Hz for 47 minutes. After 47 minutes, add the second frequency channel at 10.14 Hz. Both stay on for the remainder of the cycle. At the balance of the cycle, with the high frequency, turn off the main frequency, and let cool down to ambient air temperature. Then once ambient air temperature reached, release the negative pressure in the chamber.

### NONSTRUCTURAL APPLICATION

Step 22A. Put a bladder filled with non-Newtonian fluid against the rear of the assembly. Rubber aircraft fuel bladder made with polyurea. Attach bladder with 100% silicone to outside perimeter of the assembly; 1 gram per ten centimeters (1 g/cm) of perimeter. A preferred non-Newtonian fluid is a mixture of 4% nontoxic anti-freeze with 96% crystalline silica.

### STRUCTURAL SHRAPNEL-RESISTANT APPLICATION

Step 22B. Enclose the product within a canvas bag.

### STRUCTURAL NON-SHRAPNEL-RESISTANT MODULAR APPLICATION

Step 22C. Without placing a bladder behind the product, drill holes through the product from the front to the rear and through the layers of the laminate. Insert a fastener (for example, a bolt) through the holes drilled in the product and screw the fastener into an underlying substructure.

### PREFABRICATED MODULAR STRUCTURAL EXTREME SHRAPNEL-RESISTANT APPLICATION

New cast panel with bladder behind it. (Cast panel) will be on newly designed radius cutout for ease of assembly on newly fabricated panels. These panels have a nanothreaded ferrofluid charged wings to fasten together on the inside of panel to make a monolithic one unit panel . . . comprising of a minimum of at least two panels. Could use rigid inconel steel spider clip that is mechanically fastened such as those sold under the trade name

### EXTREME HIGH IMPACT GLAZING

Put nano fibers into aluminum frame.

What is claimed is:

1. A process for making lightweight armor, which comprises:
grinding particles of rare-earth material to a particle size between ten and twenty nanometers to create processed rare-earth material;
mixing said processed rare-earth material with a positively charged aqueous dispersion to create a slurry;
admixing said slurry to silica gel to create a rare-earth gel;
sublimating said rare-earth gel by increasing at least one of temperature and pressure;
deposing rare-earth-material nanoparticles by decreasing at least one of the temperature and the pressure;
dehydrating said rare-earth material nanoparticles to form a nanoparticle powder;
sublimating silicone graphene by increasing at least of temperature and pressure to created sublimated graphene;
deposing graphene powder by reducing at least one of the temperature and the pressure of said sublimated graphene;
mixing said graphene powder and said nanoparticle powder to make graphene/nanoparticle powder;
admixing epoxy resin with said graphene/nanoparticle powder to make nanoparticle epoxy resin;
grinding said nanoparticle epoxy resin to one nanometer particle size;
admixing epoxy-resin hardener to said nanoparticle epoxy resin to make a hardening nanoparticle epoxy resin;
applying said hardening nanoparticle epoxy resin to a sheet of polyaramid to produce a nanoparticle enriched sheet;
pressing said nanoparticle enriched sheet to produce a pressed nanoparticle enriched sheet;
curing said pressed nanoparticle enriched sheet by applying heat to create a cured nanoparticle enriched sheet; and
cold stretching said cured nanoparticle enriched sheet to produce a stretched and cured nanoparticle enriched sheet.

2. The process according to claim 1, which further comprises selecting said rare-earth material is a metal acetylacetonate.

3. The process according to claim 1, which further comprises selecting the metal acetylacetonate from the group consisting of magnesium acetylacetonate, manganese acetylacetonate, sodium acetylacetonate, aluminum acetylacetonate, and yttrium (III) acetylacetonate.

4. The process according to claim 1, wherein said positively charged aqueous dispersion includes a ferrofluid.

5. The process according to claim 1, wherein said silicate is tetraethyl orthosilicate.

6. The process according to claim 1, which further comprises:
after forming said nanoparticle powder, re-sublimating said nanoparticle powder; and
re-deposing said nanoparticle powder.

7. The process according to claim 1, which further comprises:
re-sublimating said graphene powder into sublimated graphene; and
redisposing said sublimated graphene as graphene powder.

8. The process according to claim 1, wherein said mixing of said graphene powder and said nanoparticle powder is at a mass ratio of two to one.

9. The process according to claim 1, which further comprises:
sublimating said graphene/nanoparticle powder into sublimated graphene/nanoparticle powder; and
deposing graphene/nanoparticle powder from said sublimated graphene/nanoparticle powder.

10. The process according to claim 1, which further comprises exposing said stretched and cured nanoparticle enriched sheet to sound.

11. The process according to claim 12, wherein said sound is between 7.83 Hz and 30 Hz.

12. The process according to claim 11, wherein said exposing to sound is for at least fifteen minutes.

13. The process according to claim 1, which further comprises cutting said stretched and cured nanoparticle enriched sheet to a shape.

14. The process according to claim 1, which further comprises pyroprocessing said stretched and cured nanoparticle enriched sheet.

15. The process according to claim 1, which further comprises dehydrating said stretched and cured nanoparticle enriched sheet.

16. The process according to claim 1, which further comprises pressing said stretched and cured nanoparticle enriched sheet.

17. A process for making a hardened cast, which comprises:
pouring a slurry of processed rare-earth material and a positively charged aqueous dispersion into a mold;
curing said slurry in said mold by applying at least one of heat and negative pressure until dry to make a hardened part within said mold.

18. The process for making a reinforced hardened part, which comprises applying a stretched and cured nanoparticle enriched sheet to a hardened part, said stretched and cured nanoparticle enriched sheet being made according to the process of claim 1, said hardened part being made according to the process of claim 17.

19. The process according to claim 18, which further comprises applying a layer of polyethylene between said stretched and cured nanoparticle enriched sheet and said hardened part.

20. The process according to claim 18, which further comprises applying a further hardened part to said stretched and cured nanoparticle enriched sheet, said hardened part and said further hardened part being disposed on opposing sides of said stretched and cured nanoparticle enriched sheet.
